(19) United States
(12) Patent Application Publication
(10) Pub. No.: US 2014/0181124 A1
(43) Pub. Date: Jun. 26, 2014

(54) METHOD, APPARATUS, SYSTEM AND STORAGE MEDIUM HAVING COMPUTER EXECUTABLE INSTRUTIONS FOR DETERMINATION OF A MEASURE OF SIMILARITY AND PROCESSING OF DOCUMENTS

(71) Applicant: DOCUWARE GMBH, Germering (DE)

(72) Inventors: Andreas HOFMEIER, Dachau (DE); Christoph WEIDLING, Muenchen (DE); Michael BERGER, Germering (DE)

(73) Assignee: DOCUWARE GMBH, Germering (DE)

(21) Appl. No.: 14/138,407

(22) Filed: Dec. 23, 2013

(30) Foreign Application Priority Data
Dec. 21, 2012 (DE) 102012025349.4

(51) Int. Cl. G06F 17/30

(52) U.S. Cl. CPC G06F 17/30011
USPC 707/749

(57) ABSTRACT

A method determines a measure of similarity between a first document and a second document, in which a vector space model which takes into account word frequencies and coordinates is determined for the first document and for the second document. A measure of the similarity between the first document and the second document is determined using the vector space model. An apparatus, a computer program product and a storage medium are configured to execute the method.

### CROSS-REFERENCE TO RELATED APPLICATION

This application claims the priority, under 35 U.S.C. §119, of German application DE 10 2012 025 349.4, filed Dec. 21, 2012; the prior application is herewith incorporated by reference in its entirety.

### BACKGROUND OF THE INVENTION

### Field of the Invention

The invention relates to the determination of a measure of similarity between two documents and to processing of documents on the basis of a measure of similarity.

Different text recognition (also referred to as optical character recognition (OCR)) methods which can be used to recognize text inside images in an automated manner are known. The images are, for example, electronically scanned documents, the content of which is intended to be analyzed further.

The documents may be electronic documents, for example electronically processed, preprocessed or processable documents. The approach can be used, for example, in applications relating to document management or document archiving, for example of business documents, but can also be used for other types of data extraction, for example extraction of information from photographed till receipts and other small documents.

In document management, index data relating to a document, for example sender, recipient, invoice number or invoice amount, play a central role. A document management system provides, for example, search functions using index data or archives a document using its index data.

Index data extraction (also referred to as “extraction”) denotes automatic determination of index data relating to a document. In addition to rule-based methods, use is also made of learning methods which determine the index data relating to a document using similar documents (so-called training documents) whose index data have already been confirmed or corrected by a user.

A measure of similarity for comparing documents is known. Distance determination methods (Euclidean distance, vector space models and probabilistic methods) are thus applied to the problem of determining the distance between documents. An overview of the different methods is found, for example, in an article by A. Huang, entitled “Similarity Measures for Text Document Clustering” edited by J. Holland, A. Nicholas, and D. Brignoli, and in New Zealand Computer Science Research Student Conference, pages 49-56, April 2008]. In this case, the sets of words of the two documents are generally compared (“bag of words” approach) and/or semantic analyses are carried out.

An article by Michael W. Berry, Zlatko Drmac, and Elizabeth R. Jessup; entitled “Matrices, Vector Spaces, and Information Retrieval”, SIAM review, 1999, Vol. 41, No. 2, pages 335-362, relates to an analysis method for titles of documents in an archive. In this case, a measure of similarity between the words in the title is determined from expressions in the document by means of the cosine of a query and a document vector.

An article by Jianying Hu, Ramanujan Kashi, and Gordon Wilfong; entitled “Document Image Layout Comparison and Classification, Document Analysis and Recognition”, 1999 uses a method in which a document page is subdivided into an m×n grid and it is determined whether or not each cell contains text. The information obtained is then used to infer a document type, for example whether the document is a letter, a professional article or a journal.

An article by Daniel Esser et al.; entitled “Automatic Indexing of Scanned Documents—a Layout-based Approach, Document Recognition and Retrieval XIX”, Proc. of SPIE Vol. 8297, 82970H uses a method in which predetermined words are searched for in selected sectors of a document. This reduces a number of available templates of different document types to be evaluated. In this case, use is made of words which already exist in the underlying template with certain starting positions x and y inside the document.

However, the known approaches have disadvantages if the determination of the similarity of documents whose text and layout need to be considered is involved.

### SUMMARY OF THE INVENTION

The object of the invention is to avoid the abovementioned disadvantages and to specify, in particular, an efficient solution for determining the similarity between electronic documents and to provide possibilities for processing documents which use a similarity between documents which is determined in this manner.

In order to achieve the object, a method for determining a measure of similarity between a first document and a second document is proposed, in which a vector space model which takes into account word frequencies and coordinates is determined for the first document and for the second document, in which a measure of the similarity between the first document and the second document is determined using the vector space model.

The present approach has the advantage that the text and the layout of the documents to be compared are taken into account for the purpose of determining the similarity. An additional advantage is that, in addition to the similarity of the documents, the similarity of the index data relating to the documents can also be taken into account. It is therefore possible, for example, to quickly identify a document which has been erroneously or deliberately provided with incorrect index data by a user.

The present solution allows a suitable measure of the similarity between two documents to be determined, for example a function which assigns a value of between 0 and 1 to each tuple of two documents. In this case, this value is higher, the more similar the two documents are with respect to content (i.e. vocabulary) and layout and assume the value 1, for example, when the two documents are identical.

One development is that the coordinates of those words which occur together in both documents are taken into account.

Another development is that the vector space model is determined by determining a first vector for the first document and a second vector for a second document.

One development is, in particular, that the measure of the similarity is determined by determining a cosine between the first vector and the second vector.

A development is also that a respective word vector is determined for the first document and for the second document. Elements of the word vectors indicate whether or not a word occurs in the respective document a word distance between the documents is determined. A respective coordinate vector is determined for the first document and for the second document. Elements of the word vectors indicating coordinates for words which occur together in the two documents. A coordinate distance between the documents is determined, and a total distance is determined on the basis of the word distance and the coordinate distance.

For example, an element “1” denotes that the word occurs in the respective document (an element “0” accordingly denotes that the word does not occur and an element “4” denotes, for example, that the word occurs four times); the position of the element inside the word vector is linked to a particular word in this case. The coordinate vector contains, for example for each jointly occurring word in each document, two entries, for example for x and y coordinates within the respective document.

One development involves determining the word distance using a cosine between the word vectors.

One development also involves determining the coordinate distance using a cosine between the coordinate vectors.

A next development involves determining the total distance according to

(1−p)s+p·t

where s denotes the word distance, t denotes the coordinate distance and p denotes a predefinable parameter.

One refinement is that words occurring repeatedly in both documents are compared with one another in the coordinate vector according to one of the following mechanisms in accordance with their occurrence, using an assignment method in which those words for which the sum of the distances between the compared pairs is as small as possible are compared, using an assignment method in which those words for which the sum of the distances between the compared pairs is as large as possible are compared.

In this case, the comparison denotes the use of identical positions inside the two vectors.

The above object is also achieved by a method for processing an electronic document, in which a super ordinate database for extracting information is adapted on the basis of an electronic document if no documents which are sufficiently similar to the electronic document are present in the super ordinate database, the similarity between the electronic document and documents present in the super ordinate data bank being determined in accordance with the abovementioned method.

This approach can be used repeatedly for a plurality of levels of super ordinate model spaces (model space corresponds to the abovementioned database here).

In this case, it is advantageous that it is possible to interchange document information between individual users as a result of the cross-organizational approach.

In the case of organization-based or company-based document management, users (for example companies) (also) provide a super ordinate model space (also referred to as a super ordinate database) or a multilevel hierarchy containing such super ordinate model spaces, for example, with their documents which have already been provided with correct index data. If another user now carries out extraction for a document, similar documents from the super ordinate model spaces can be used to determine the index data.

In this case, the super ordinate model spaces can be used in different ways.

First of all, the question arises of which documents from a user are intended to be supplied to the super ordinate model spaces up to which level of the hierarchy. On the one hand, it is desirable to provide only a small number of documents in terms of efficient storage space use. On the other hand, a large number of provided documents increases the likelihood of a current document being successfully indexed (that is to say of index data extraction for the current document being successful) by virtue of a sufficient number of similar documents being able to be provided.

A set of documents which is as small as possible, but where the total set represents the documents of all users to be processed as well as possible with regard to their similarity, is therefore sought.

An alternative embodiment involves adapting the super ordinate database by adding the electronic document or features of the electronic document to the super ordinate database.

For example, index data or other data characteristic of the document can be added to the super ordinate database.

A method for processing an electronic document is also proposed, in which a super ordinate database is used to extract information relating to the document, only those documents in the super ordinate database which have a predefined similarity to the electronic document being used, the similarity between the electronic document and documents present in the super ordinate data bank being determined in accordance with the method explained here.

A next refinement is that the predefined similarity is determined by a threshold value comparison with a predefined minimum measure of similarity.

A refinement is also that the super ordinate database is used to extract information relating to the document if the super ordinate database has more similar documents than a local database.

The local database may be a local model space, in particular in the form of a data bank. The local database and the super ordinate database may contain already classified documents, document types, items of feedback from the user, data fields, values for data fields, etc.

The super ordinate database may be a database of a further physical or logical unit which may be separate from a first unit containing the local database.

In particular, it is possible to provide a plurality of super ordinate databases which are hierarchically arranged; accordingly, the present proposal can be carried out several times in succession in order to obtain a sufficiently good extraction result for the document across a plurality of hierarchical levels.

A particular advantage of the solution presented is that the local database is used in a first step and the material (documents, classifications, fields, values, coordinates, etc.) already present locally is therefore used to produce the best possible classification result; this can be expected, in particular, for those document types which have already been extracted often and for which extensive extraction knowledge is accordingly stored in the local database. If no sufficient extraction knowledge is found locally, the escalation in the super ordinate database uses the information which is available there and possibly comes from a different organizational structure and/or from a different extraction service.

The present solution makes it possible for a current user to benefit, in particular, from extraction results which have already been carried out, for example caused or carried out by other users or processes, by virtue of the extraction results being improved or only just enabled for the current user thereby.

For example, extraction services in electronic documents (data extraction services and/or model spaces with training documents which are managed by the data extraction services) can be interconnected in a freely definable hierarchy, in particular without the current user being able to draw conclusions on the contents of the documents belonging to the other users. The confidentiality of the contents is therefore ensured and the extraction results which have already been carried out can nevertheless be used.

The abovementioned object is also achieved by an apparatus for determining a measure of similarity between a first document and a second document, having a processing unit which is set up in such a manner that in which a vector space model which takes into account word frequencies and coordinates can be determined for the first document and for the second document, and in which a measure of the similarity between the first document and the second document can be determined using the vector space model.

The object is also achieved by an apparatus for processing an electronic document, having a processing unit which is set up in such a manner that the steps of the method described herein can be carried out.

The processing unit mentioned here may be, in particular, in the form of a processor unit, a computer or a distributed system of processor units or computers. In particular, the processing unit may have computers which are connected to one another via a network connection, for example via the Internet.

The database may be or contains a data bank or a data bank management system.

In particular, the processing unit may be or contains any type of processor or computer with accordingly required peripherals (memory, input/output interfaces, input/output devices, etc.).

The above explanations relating to the method accordingly apply to the apparatus. The apparatus may be in one component or distributed in a plurality of components.

One refinement is that the apparatus contains the local database and/or the super ordinate database.

The abovementioned object is also achieved by a system containing at least one of the apparatuses described here.

The solution presented here also contains a computer program product which can be loaded directly into a memory of a digital computer, containing program code parts which are suitable for carrying out steps of the method described here.

The abovementioned problem is also solved by a non-transitory computer-readable storage medium, for example any desired memory, containing instructions (for example in the form of program code) which can be executed by a computer and are suitable for the computer to carry out steps of the method described here.

The above-described properties, features and advantages of this invention and the manner in which they are achieved become more clearly and distinctly comprehensible in connection with the following schematic description of exemplary embodiments which are explained in more detail in connection with the drawings. For the sake of clarity, in this case, identical or identically acting elements can be provided with the identical reference symbols.

Other features which are considered as characteristic for the invention are set forth in the appended claims.

Although the invention is illustrated and described herein as embodied in a determination of a measure of similarity and processing of documents, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a propagation strategy of documents across model spaces;

FIG. 2 is a schematic image of an invoice as an exemplary document with blocks, coordinates and recognized words;

FIG. 3 is a schematic image of an invoice, which is similar but alternative to FIG. 2, with blocks, coordinates and recognized words; and

FIG. 4 is a schematic image of a cover letter with blocks, coordinates and recognized words.

### DETAILED DESCRIPTION OF THE INVENTION

An approach based on two vector space models is proposed as a measure of similarity between documents. The documents are therefore transformed into a multidimensional vector and the cosine is calculated between two vectors.

In the vector space models, it is possible to use the word frequencies and coordinates of the shared words which, if they occur repeatedly, are compared with the aid of a heuristic matching method.

For example, use is made of a second vector space model which is used to carry out the method for the index data relating to the documents. The results of the two vector space models are then processed to form an overall result.

A propagation strategy is now described.

A document provided with index data by a user can be added to a hierarchy of the super ordinate model spaces. In this case, the hierarchy is run through from bottom to top and the most similar documents in each super ordinate model space are determined, the similarity of the documents being measured with the aid of the abovementioned vector space models.

As long as a sufficient number of sufficiently similar documents is not in a super ordinate model space, the document is added to the super ordinate model space. When a number of similar documents is sufficient depends, for example, on the learning methods or on a (predefined or predefinable) number of similar documents which require this in order to ensure a sufficient quality of the index data extraction. The quality can be determined, for example, using a measure of extraction quality, for example by comparing the measure of quality with a predefined threshold value.

When a document is sufficiently similar to be considered a “similar document” can also be determined using a threshold value. The process of running through the hierarchy is ended as soon as a super ordinate model space is found, to which the document is no longer intended to be added, or as soon as a super ordinate model space no longer exists.

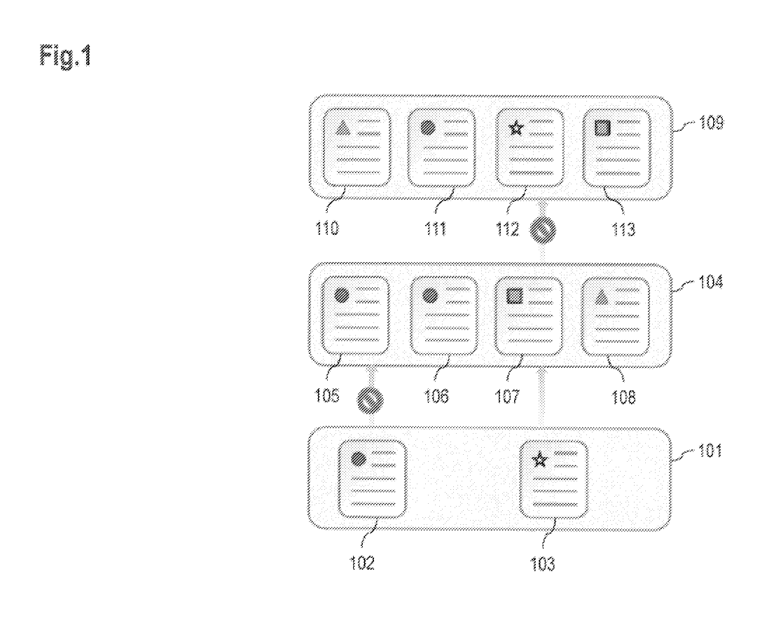

FIG. 1 shows a schematic illustration of the abovementioned propagation strategy. Two documents 102 and 103 from a model space 101 are provided with index data.

A super ordinate model space 104 (first hierarchical level) contains four documents 105 to 108 and a further super ordinate model space 109 (second hierarchical level) contains four documents 110 to 113.

For document 102, there are already similar documents 105 and 106 in the super ordinate model space 104. Therefore, document 102 is not added to the super ordinate model space 104. The further super ordinate model spaces are no longer checked for document 102.

For document 103, there are no similar documents 105 to 108 in the super ordinate model space 104. Document 103 is added to the super ordinate model space 104. For document 103, there is a similar document 112 in the super ordinate model space 109. Therefore, document 103 is not added to the super ordinate model space 109.

The query strategy is now described.

There are two query strategies:

(1) In the first query strategy, every super ordinate model space is used for index data extraction. This constitutes the greatest possible certainty of obtaining actually similar documents during index data extraction but is runtime-intensive.
(2) In the second query strategy, the super ordinate model spaces are not fundamentally used for index data extraction. Instead, only the most similar documents from each super ordinate model space are determined (which is considerably less runtime-intensive than complete index data extraction). The similarity is again determined using the vector space models. Index data extraction is now extended to that super ordinate model space which contains the most similar documents and this is also affected only when the documents are more similar than the documents already available in the actual model space.

Further embodiments and advantages are now discussed.

A first strategy for using a hierarchy of super ordinate model spaces in an organization-based document management process is proposed. In this case, the distance between documents is determined, with the similarity of the layout, of the vocabulary and of the index data being taken into account.

Therefore, the present solution allows a strategy for collaboration and for interchanging documents, in particular in organization-based document management.

Further statements on the vector space model are now described.

The following example is intended to illustrate the procedure when calculating the distance between documents.

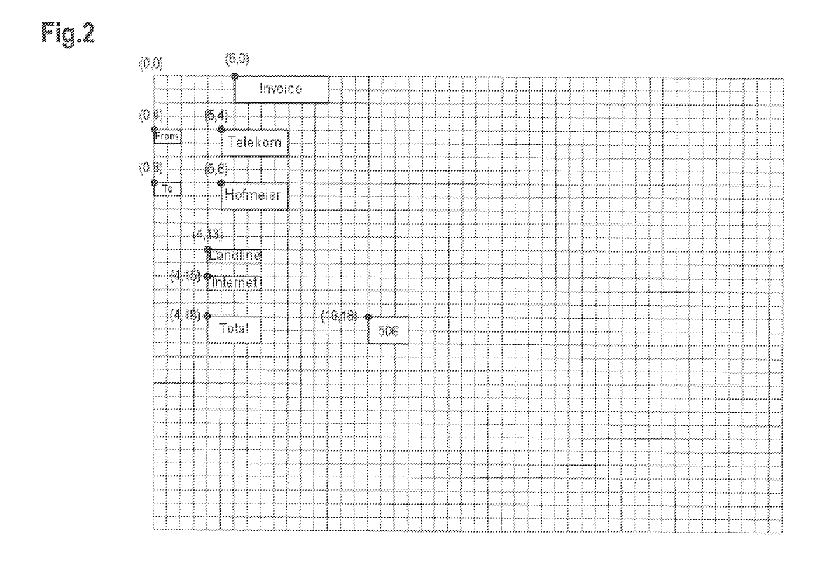

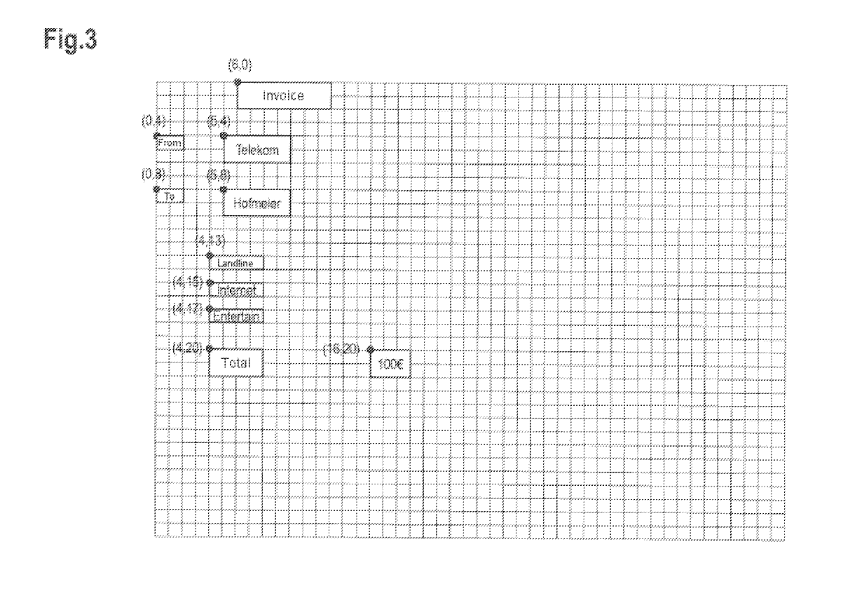

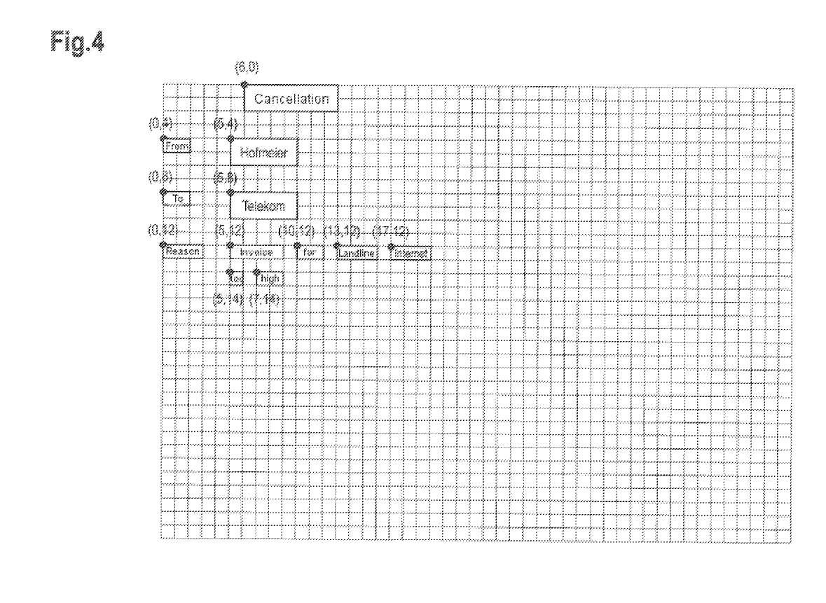

FIG. 2 shows a document of an invoice from “Telekom” to “Hofmeier” with a plurality of text blocks whose upper left-hand corner is respectively linked to a coordinate of the document. The position of the respective text block in the document is therefore defined. By way of example, the coordinate origin (0.0) is in the upper left-hand corner. The invoice has, inter alia, two invoice items “landline” and “Internet”. FIG. 3 shows a document of an invoice from “Telekom” to “Hofmeier” which, in contrast to FIG. 2, has three invoice items “landline”, “Internet” and “Entertain”. FIG. 4 shows a further exemplary document of a cancellation from “Hofmeier” to “Telekom”.

The documents shown in FIGS. 2 to 4 each have approximately 12 words. The words with their upper left-hand indication of coordinates are, for example, the result of OCR preprocessing, for example after the documents have been scanned. In order to simplify the present example, the words occur at most once for each document.

The documents in FIGS. 2 and 3 are similar to one another since both invoices from the same invoicing party are addressed to the same addressee. The document according to FIG. 3 is a “letter of cancellation” which, apart from very similar vocabulary, has only little similarity to the documents in FIGS. 2 and 3.

The text below explains how a value can be determined for similarities between documents. For example, the value can vary between 0 (documents are fundamentally different from one another) and 1 (documents are identical).

Calculation of distance between document 1 (FIG. 2) and document 2 (FIG. 3) is now described.

Step 1: Determination of word vectors is now described.

A vector is created for each of the two documents. The number of dimensions of the two vectors is identical and respectively corresponds to the number of different words occurring in total in the two documents.

In the example, these are the words: “invoice”, “from”, “Telekom”, “to”, “Hofmeier”, “landline”, “Internet”, “Entertain”, “total”, “100 [symbol] ” and “50 [symbol] ”. Therefore, each vector has 11 dimensions.

The value of a dimension in a document corresponds to the number of occurrences of the corresponding word.

For the example, the following vectors result (document 1 according to FIG. 2 on the left and document 2 according to FIG. 3 on the right):

$$\begin{matrix}\begin{matrix}Invoice \\ From \\ Telekom \\ To \\ Hofmeier \\ Landline \\ Internet \\ Entertain \\ Total \\ 100 ∈ \\ 50 ∈\end{matrix} ( \begin{matrix}1 \\ 1 \\ 1 \\ 1 \\ 1 \\ 1 \\ 1 \\ 0 \\ 1 \\ 0 \\ 1\end{matrix} ) & \\ \begin{matrix}Invoice \\ From \\ Telekom \\ To \\ Hofmeier \\ Landline \\ Internet \\ Entertain \\ Total \\ 100 ∈ \\ 50 ∈\end{matrix} ( \begin{matrix}1 \\ 1 \\ 1 \\ 1 \\ 1 \\ 1 \\ 1 \\ 1 \\ 1 \\ 1 \\ 0\end{matrix} ) & \end{matrix}$$

Step 2: Calculation of the word distance is now described.

The word distance between the two documents corresponds to the cosine between their word vectors v₁ and v₂ according to:

$$\frac{Scalar product ( {v}_{1} , {v}_{2} )}{Norm ( {v}_{1} ) \cdot Norm ( {v}_{2} )}$$

The scalar product s of two vectors v₁=(x₁, . . . , xₙ) and v₂=(y₁, . . . , yₙ) is calculated as follows in this case:

$$s = {\sum }_{i = 1}^{n} ( {x}_{i} \cdot {y}_{i} )$$

The norm of a vector v=(x₁, . . . , xₙ) is determined by:

$$t = \sqrt{{\sum }_{i = 1}^{u} {x}_{i}^{2}}$$

In the example, the following therefore results as the word distance:

$$Word distance = \frac{8}{\sqrt{0} \cdot \sqrt{10}} \approx 0.81$$

Step 3: Construction of the coordinate vectors is now described.

A vector is created for each of the two documents. The number of dimensions of the two vectors is identical and respectively corresponds to twice the number of words occurring in both documents.

If a word repeatedly occurs in both documents (not the case in the example for the sake of simplicity), the number of dimensions is accordingly increased. If a word occurs three times in the first document and five times in the second document, for example, six (two times three) dimensions are added to the vectors for this word.

Assuming the word “hello” occurs five times in the first document and three times in the second document, three pairs of “hello” assignments are formed, for example:

1. the first “hello” from document 1 and the first “hello” from document 2,
2. the third “hello” from document 1 and the second “hello” from document 2, and
3. the fifth “hello” from document 1 and the third “hello” from document 2.

Since document 2 contains the word “hello” only three times, three pairs are formed. Each word pair formed preferably has two dimensions, namely the x and y coordinates as positions in the respective document. Six additional dimensions therefore result for the vector.

Alternatively, it is possible to compare each occurrence of the word “hello” in document 1 with each occurrence of the word “hello” in document 2 in a separate pair and therefore to form 15 pairs (each with two dimensions for the coordinates).

In particular, all possible pairs of words occurring in both documents can be compared using an assignment method.

In the example, the words which occur repeatedly in both documents are: “invoice”, “from”, “Telekom”, “to”, “Hofmeier”, “landline”, “Internet” and “total”. Therefore, each vector has 16 (two times eight, two coordinates for each shared word) dimensions.

In the two dimensions of a word, its x and y coordinates are used as values.

For the example, the following vectors result (on the left for document 1 and on the right for document 2):

$$\begin{matrix}\begin{matrix}Invoice \\ \\ From \\ \\ Telekom \\ \\ To \\ \\ Hofmeier \\ \\ Landline \\ \\ Internet \\ \\ Total \\ \end{matrix} ( \begin{matrix}6 \\ 0 \\ 0 \\ 1 \\ 5 \\ 4 \\ 0 \\ 8 \\ 5 \\ 8 \\ 4 \\ 13 \\ 4 \\ 15 \\ 4 \\ 18\end{matrix} ) & \\ \begin{matrix}Invoice \\ \\ From \\ \\ Telekom \\ \\ To \\ \\ Hofmeier \\ \\ Landline \\ \\ Internet \\ \\ Total \\ \end{matrix} ( \begin{matrix}6 \\ 0 \\ 0 \\ 4 \\ 5 \\ 4 \\ 0 \\ 8 \\ 5 \\ 8 \\ 4 \\ 13 \\ 4 \\ 15 \\ 4 \\ 20\end{matrix} ) & \end{matrix}$$

Step 4: Calculation of a coordinate distance is now described.

The coordinate distance between the two documents corresponds to the cosine between their coordinate vectors. This is likewise calculated with the formula already mentioned. In the example, the following coordinate distance then results:

$$Coordinate distance = \frac{1048}{\sqrt{1012} \cdot \sqrt{1088}} \approx 0.99$$

Step 5: Determination of the total distance from the word distance and coordinate distance is now described.

The word distance s and the coordinate distance t are now calculated according to the formula

(1−p)s+p·t

to form a total distance. The parameter p corresponds to a predefined constant of less than 1.

The calculation means the following: If the word distance has a very low value (which corresponds to a long distance), it is given a high weighting and if, in contrast, it has a very high value (which corresponds to a very short distance), it is given a low weighting and the coordinate distance is accordingly given a high weighting.

In the example, the following results are now discussed.

Total distance: 0.16*0.84+0.84*0.99 0.96

Calculation of distance between document 1 (FIG. 2) and document 3 (FIG. 4) is now described.

The distance between document 1 and document 3 is calculated in a corresponding manner and is therefore explained only briefly in order to discern how the different layout of the two documents has an effect on the distance.

The following word vectors result:

$$\begin{matrix}\begin{matrix}Invoice \\ From \\ Telekom \\ To \\ Hofmeier \\ Landline \\ Internet \\ Total \\ 50 ∈ \\ Cancellation \\ Reason \\ for \\ too \\ high\end{matrix} ( \begin{matrix}1 \\ 1 \\ 1 \\ 1 \\ 1 \\ 1 \\ 1 \\ 1 \\ 1 \\ 0 \\ 0 \\ 0 \\ 0 \\ 0\end{matrix} ) & \\ \begin{matrix}Invoice \\ From \\ Telekom \\ To \\ Hofmeier \\ Landline \\ Internet \\ Total \\ 50 ∈ \\ Cancellation \\ Reason \\ for \\ too \\ high\end{matrix} ( \begin{matrix}1 \\ 1 \\ 1 \\ 1 \\ 1 \\ 1 \\ 1 \\ 0 \\ 0 \\ 1 \\ 1 \\ 1 \\ 1 \\ 1\end{matrix} ) & \end{matrix}$$

The word distance therefore results as:

$$\frac{7}{\sqrt{9} \cdot \sqrt{12}} \approx 0.67$$

The following result as coordinate vectors

$$\begin{matrix}\begin{matrix}Invoice \\ \\ From \\ \\ Telekom \\ \\ To \\ \\ Hofmeier \\ \\ Landline \\ \\ Internet \\ \end{matrix} ( \begin{matrix}6 \\ 0 \\ 0 \\ 4 \\ 5 \\ 4 \\ 0 \\ 8 \\ 5 \\ 8 \\ 4 \\ 13 \\ 4 \\ 15\end{matrix} ) & \\ \begin{matrix}Invoice \\ \\ From \\ \\ Telekom \\ \\ To \\ \\ Hofmeier \\ \\ Landline \\ \\ Internet \\ \end{matrix} ( \begin{matrix}5 \\ 12 \\ 0 \\ 4 \\ 5 \\ 8 \\ 0 \\ 8 \\ 5 \\ 4 \\ 13 \\ 12 \\ 17 \\ 12\end{matrix} ) & \end{matrix}$$

and the coordinate distance therefore results as

$$\frac{680}{\sqrt{672} \cdot \sqrt{1125}} \approx 0.78$$

The total distance is therefore approximately 0.74.

Further variation possibilities are now described.

If a word repeatedly occurs in both documents, a decision should be made regarding which occurrences are “compared” (or assigned) in the coordinate vector. The following variants result here, for example:

a). The first occurrence of the word in document 1 is assigned to the first occurrence of the word in document 2. Accordingly, the second occurrence of the word in document 1 is assigned to the second occurrence of the word in document 2, etc.
b). An assignment method is used in which the occurrences of the word are compared in such a manner that the sum of the distances between the compared pairs is as small as possible.
c. An assignment method is used in which the occurrences of the word are compared in such a manner that the sum of the distances between the compared pairs is as large as possible.

One variation is the choice of the parameter p when calculating the total distance from the word distance and the coordinate distance. For example, p=0.5 (or any other constant less than one) could be selected.

Although the invention was described and illustrated in more detail by means of the at least one exemplary embodiment shown, the invention is not restricted thereto and other variations can be derived therefrom by a person skilled in the art without departing from the scope of protection of the invention.

1. A method for determining a measure of similarity between a first document and a second document, which comprises the steps of:
determining a vector space model which takes into account word frequencies and coordinates for the first document and for the second document;
determining the measure of similarity between the first document and the second document using the vector space model;
determining a respective word vector for the first document and for the second document, elements of word vectors indicating whether or not a word occurs in a respective document;
determining a respective coordinate vector the first document and for the second document, elements of coordinate vectors indicating coordinates for words which occur together in the first and second documents; and
comparing the words which repeatedly occur in both the first and second documents with one another in the respective coordinate vector.

2. The method according to claim 1, which further comprises taking into account the coordinates of the words which occur together in both the first and second documents.

3. The method according to claim 1, which further comprises determining the vector space model by ascertaining a first vector for the first document and a second vector for the second document.

4. The method according to claim 3, which further comprises determining the measure of the similarity by determining a cosine between the first vector and the second vector.

5. The method according to claim 1, which further comprises:
determining a word distance between the first and second documents;
determining a coordinate distance between the first and second documents; and
determining a total distance on a basis of the word distance and the coordinate distance.

6. The method according to claim 5, which further comprises determining the word distance using a cosine between the word vectors.

7. The method according to claim 5, which further comprises determining the coordinate distance using a cosine between the coordinate vectors.

8. The method according to claim 5, which further comprises determining the total distance according to
(1−p)s+p·t
where s denotes the word distance, t denotes the coordinate distance and p denotes a predefinable parameter.

9. The method according to claim 5, which further comprises comparing the words occurring repeatedly in both the first and second documents with one another in the coordinate vector according to one of the following mechanisms:
in accordance with their occurrence;
using an assignment method in which the words for which a sum of distances between compared pairs is as small as possible are compared; and
using the assignment method in which the words for which the sum of the distances between the compared pairs is as large as possible are compared.

10. A method for processing an electronic document, which comprises the steps of:
adapting a super ordinate database for extracting information on a basis of an electronic document if no documents which are sufficiently similar to the electronic document are present in the super ordinate database; and
determining a similarity between the electronic document, being a first document, and other documents including a second document present in the super ordinate data bank in accordance with a method according to claim 1.

11. The method according to claim 10, which further comprises adapting the super ordinate database by adding the electronic document or features of the electronic document to the super ordinate database.

12. A method for processing an electronic document, which comprises the steps of:
extracting information relating to the electronic document, via a super ordinate database, only documents in the super ordinate database which have a predefined similarity to the electronic document being used, a similarity between the electronic document and the documents present in the super ordinate data bank being determined in accordance with a method according to claim 1.

13. The method according to claim 12, which further comprises determining the predefined similarity by means of a threshold value comparison with a predefined minimum measure of similarity.

14. The method according to claim 12, which further comprises using the super ordinate database to extract the information relating to the electronic document if the super ordinate database has more similar documents than a local database.

15. An apparatus for determining a measure of similarity between a first document and a second document, the apparatus comprising:
a memory; and
a processing unit programmed to:
determine a vector space model taking into account word frequencies and coordinates for the first document and for the second document;
determine the measure of similarity between the first document and the second document using the vector space model;
determine a respective word vector for the first document and for the second document, elements of word vectors indicating whether or not a word occurs in a respective document; and
determine a respective coordinate vector for the first document and for the second document, elements of coordinate vectors indicating coordinates for words which occur together in the first and second documents, and the words which repeatedly occur in both of the first and second documents can be compared with one another in the coordinate vector.

16. An apparatus for processing an electronic document, the apparatus comprising:
a memory; and
a processing unit programmed to:
extract information relating to the electronic document, via a super ordinate database, only documents in the super ordinate database which have a predefined similarity to the electronic document being used, a similarity between the electronic document and the documents present in the super ordinate data bank being determined in accordance with a method according to claim 1.

17. A system for processing an electronic document, comprising:
at least one apparatus for determining a measure of similarity between a first document and a second document, said apparatus containing:
a memory; and
a processing unit programmed to:
determine a vector space model taking into account word frequencies and coordinates for the first document and for the second document;
determine the measure of similarity between the first document and the second document using the vector space model;
determine a respective word vector for the first document and for the second document, elements of word vectors indicating whether or not a word occurs in a respective document; and
determine a respective coordinate vector for the first document and for the second document, elements of the coordinate vectors indicating coordinates for words which occur together in the first and second documents, and the words which repeatedly occur in both of the first and second documents can be compared with one another in the coordinate vector.

18. Computer executable instructions to be loaded into a non-transitory memory of a digital computer, for performing a method for determining a measure of similarity between a first document and a second document, which comprises the steps of:
determining a vector space model which takes into account word frequencies and coordinates for the first document and for the second document;
determining the measure of similarity between the first document and the second document using the vector space model;
determining a respective word vector for the first document and for the second document, elements of word vectors indicating whether or not a word occurs in the respective document;
determining a respective coordinate vector the first document and for the second document, elements of coordinate vectors indicating coordinates for words which occur together in the first and second documents; and
comparing the words which repeatedly occur in both the first and second documents with one another in the respective coordinate vector.

19. A non-transitory computer-readable storage medium having computer executable instructions to be executed by a computer for performing a method for determining a measure of similarity between a first document and a second document, which comprises the steps of:
determining a vector space model which takes into account word frequencies and coordinates for the first document and for the second document;
determining the measure of similarity between the first document and the second document using the vector space model;
determining a respective word vector for the first document and for the second document, elements of word vectors indicating whether or not a word occurs in the respective document;
determining a respective coordinate vector for the first document and for the second document, elements of coordinate vectors indicating coordinates for words which occur together in the first and second documents; and
comparing the words which repeatedly occur in both the first and second documents with one another in the respective coordinate vector.
